(19) United States
(12) Patent Application Publication
(10) Pub. No.: US 2026/0189252 A1
(43) Pub. Date: Jul. 2, 2026

(54) RADIO BEACON FOR A HANDHELD RADIO

(71) Applicant: United Rentals, Inc., Stamford, CT (US)

(72) Inventors: Steve Anderson, Stamford, CT (US); Jason Farmer, Stamford, CT (US); Chris Cox, Stamford, CT (US); John Mongan, Stamford, CT (US); Jatin Talreja, Wichita, KS (US); Dali Basor, Wichita, KS (US); Maximiliano Cordoba, Wichita, KS (US); Mark Haas, Wichita, KS (US); Angel Martin, Wichita, KS (US)

(21) Appl. No.: 19/427,056

(22) Filed: Dec. 19, 2025

Related U.S. Application Data
(60) Provisional application No. 63/740,428, filed on Dec. 31, 2024.

(51) Int. Cl. H04B 1/034; H04B 1/04; H04W 4/80

(52) U.S. Cl. CPC H04B 1/0346; H04B 1/04; H04W 4/80

(57) ABSTRACT

A handheld radio for a construction job site includes a radio body housing a communications component therein. The handheld radio further includes an antenna communicatively coupled with the communications component and protruding from the radio body and configured to deliver and receive a communications signal. The handheld radio further includes a volume selector knob protruding from the radio body and operable to change a volume of sound emanating from the radio body. The handheld radio further includes a channel selector knob protruding from the radio body and operable to cause the antenna to deliver and receive the communications signal on one or more radio channels. The channel selector knob includes a beacon configured to emit a short-range wireless signal.

### CROSS REFERENCE TO RELATED APPLICATIONS

The present application relates and claims priority to U.S. patent application Ser. No. 63/740,428, entitled “RADIO BEACON FOR A HANDHELD RADIO,” filed on Dec. 31, 2024, which is hereby incorporated by reference in its entirety.

### TECHNICAL FIELD

The described examples relate generally to systems, devices, and techniques for tracking handheld radios on a job site.

### BACKGROUND

Construction job sites and other job sites may employ numerous personnel engaged in the collective and cooperative activity of constructing a project, including constructing and maintaining buildings, facilities, and equipment of all different types. Throughout the project, personnel may require use of certain handheld radios to complete certain job tasks and/or to otherwise facilitate management, coordination and resource control on the job site. Conventional systems and toolboxes for construction related projects often lack the ability to track the usage and location of such handheld radios, for example, because the handheld radio may lack the functionality to be tracked by an external system, such as an on-site toolbox and/or other tracking system. Further, conventional techniques associated with mere affixation of an external tracking device on the handheld radio often fail to account for harsh working conditions on the jobsite and/or other factors that render such techniques undesirable. For example, external affixation of external tracking devices on handheld radios may be susceptible to dirt, debris, damage, theft and/or other drawbacks that limit the applicability of the tracking device. As such, there is a need for systems and techniques to facilitate tracking of handheld radios on a job site.

### SUMMARY

In one example, a handheld radio for a job site is disclosed. The handheld radio includes a radio body housing a communications component therein. The handheld radio further includes an antenna communicatively coupled with the communications component. The antenna protrudes from the radio body and is configured to deliver and receive a communications signal. The handheld radio further includes a volume selector knob protruding from the radio body. The volume selector knob is operable to change a volume of sound emanating from the radio body. The handheld radio further includes a channel selector knob protruding from the radio body. The channel selector knob is operable to cause the antenna to deliver and receive the communications signal on one or more radio channels. The channel selector knob includes a beacon configured to emit a short-range wireless signal.

In another example, the short-range wireless signal may include a Bluetooth low energy signal.

In another example, the channel selector knob may include a shell defining a user engagement surface of the channel selector knob and an inner volume defined therein. The beacon may be arranged in the inner volume and concealed from an exterior environment by the user engagement surface.

In another example, the channel selector knob may further include an inner structure filling a substantial portion of the inner volume and defining a seat for the beacon proximal a tip of the shell. The beacon may be fixed to the seat.

In another example, the inner structure and the shell may cooperate to define a containment space in the inner volume that establishes an IP68 environmental resistance rating. The beacon may be fixed to the seat at and arranged fully within said containment space.

In another example, the handheld radio may further include a channel selector base connected with the radio body. The channel selector base may be operative to manipulate one or more electrical components therein. The channel selector knob may further include a post that closes the channel selector knob shell opposite the tip and is mated with the channel selector base.

In another example, rotation of the channel selector knob may cause a manipulation of the one or more electrical components via a corresponding rotation of the mated channel selector base.

In another example, the beacon may be electrically coupled to a power source of the handheld radio via the mated channel selector base and post.

In another example, the beacon is electrically coupled to a power source independent of a power source of the handheld radio via a conduit defined by the shell.

In another example, the beacon may be configured to emit the short-range wireless signal at a variable ping rate configurable to between 1 to 30 seconds.

In another example, in response to the channel selector knob being operatively coupled with the radio body, the beacon may be configured to emit the short-range wireless signal having a first characteristic. Further, in response to the channel selector knob being detached from the radio body, the beacon may be configured to emit the short-range wireless signal having a second characteristic. The second characteristic may be indicative of said detachment of the channel selector knob from the radio body.

In another example, the beacon may be configured to transmit said short-range wireless signal to a self-inventorying tool container for determination of a physical location of the handheld radio relative to the self-inventorying tool container.

In another example, the beacon may be configured to transmit said short-range wireless signal up to 100 feet.

In another example, the channel selector knob may resemble a non-Bluetooth enabled channel selector knob.

In another example, the channel selector knob is configured to emit a light associated with an operational state of the beacon.

In another example, a channel selector knob for a handheld radio is disclosed. The channel selector knob includes a shell defining a user engagement surface of the channel selector knob and an inner volume defined therein. The channel selector knob further includes a beacon configured to emit a short-range wireless signal. The beacon is arranged in the inner volume. The beacon is concealed from an exterior environment by the user engagement surface. The channel selector knob further includes an inner structure filling a substantial portion of the inner volume. The channel selector knob defines a seat for the beacon proximal to a tip of the shell. The beacon is fixed to the seat. The channel selector knob further includes a post that closes the channel selector knob shell opposite the tip. The channel selector knob defines a mating feature configured for engagement with a channel selector base of a handheld radio.

In another example, the short-range wireless signal may include a Bluetooth low energy signal.

In another example, the inner structure and the shell may cooperate to define a containment space in the inner volume that establishes an IP68 environmental resistance rating. The beacon may be fixed to the seat at and arranged fully within said containment space.

In another example, a rotation of the post may be configured to cause a manipulation of one or more electrical components of the handheld radio via a corresponding rotation of a mated channel selector base.

In another example, the beacon may be electrically couplable to a power source of the handheld radio via a mated channel selector base and post.

In another example, a method for tracking handheld radios on a job site is disclosed. The method includes providing any of the handheld radios disclosed herein to a job site within a self-inventorying tool container. The method further includes determining, using a processing unit of the self-inventorying tool container, a first location of the handheld radio based on the short-range wireless signal. The method further includes determining, using the processing unit, a second location of handheld radio based on the short-range wireless signal. The method further includes transmitting a container signal indicative of the first and second locations to a remote server.

In another example, the method may further include, using the processing unit, developing a report including a utilization metric of the handheld radio on the job site, the utilization metric indicative of a time said handheld radio is disposed outside of self-inventorying tool container.

In another example, the method may further include providing a plurality of any of the handheld radios disclosed herein to the job site within the self-inventorying tool container. The method may further include determining, using the processing unit, a subsequent location for each handheld radio of the plurality of handheld radios based on the short-range wireless signals of each respective beacon of said plurality handheld radios.

In another example, the method may further include detecting a separation event of the handheld radio in which the channel selector knob is detached from the radio body based on a change in a characteristic of the short-range wireless signal caused by said separation event.

In addition to the example aspects described above, further aspects and examples will become apparent by reference to the drawings and by study of the following description.

### BRIEF DESCRIPTION OF THE DRAWINGS

FIG. 1 depicts an example job site including an example self-inventorying tool container.

FIG. 2A depicts the self-inventorying tool container of FIG. 1 in a closed configuration.

FIG. 2B depicts the self-inventorying tool container of FIG. 1 in an open configuration, including certain trackable radios.

FIG. 3 depicts an example handheld radio.

FIG. 4A depicts an isometric view of an example channel selector knob of the handheld radio of FIG. 3.

FIG. 4B depicts a cross-sectional view of the channel selector knob of FIG. 4A, taken along line 4B-4B of FIG. 4A.

FIG. 4C depicts a detailed view of the cross-sectional view of the channel selector knob shown in FIG. 4B.

FIG. 4D depicts an exploded view of the channel selector knob of FIG. 4A.

FIG. 5A depicts an isometric view of a channel selector base component.

FIG. 5B depicts a cross-sectional view of the channel selector base component of FIG. 5A, taken along line 5B-5B of FIG. 5A.

FIG. 6A depicts a channel selector knob assembly in a first configuration.

FIG. 6B depicts a channel selector knob assembly in a second configuration.

FIG. 7A depicts an isometric view of another example channel selector knob of the handheld radio of FIG. 3.

FIG. 7B depicts a cross-sectional view of the channel selector knob of FIG. 7A, taken along line 7B-7B of FIG. 7A.

FIG. 7C depicts a detailed view of the cross-sectional view of the channel selector knob shown in FIG. 7B.

FIG. 7D depicts an exploded view of the channel selector knob of FIG. 7A.

FIG. 8 depicts a schematic top view of the example job site of FIG. 1 including the example self-inventorying tool container.

FIG. 9 depicts a flow diagram of an example method for tracking handheld radios on a job site.

FIG. 10 depicts a functional block diagram of a computer-implemented device couplable with a plurality of radios over a communications network.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various elements of the present disclosure. However, it should be understood that the described disclosure may be practiced in a variety of forms in addition to those described herein.

The following disclosure relates generally to a radio beacon for a handheld radio. The handheld radio may be substantially any handheld radio configured for short-range communication on a job site. For example, the handheld radio may be a two-way radio that permits two-way communication using, e.g., a half-duplex communication channel. In this regard, the handheld radio may be configured to send and receive short-range wireless signals over one or more channels. In turn, said short-range wireless signals transmitted from one handheld radio may be received by an associated handheld radio operating with range of the transmitting handheld radio. The handheld radio may therefore include a channel knob (to facilitate channel switching), a volume knob (to facilitate sound level), an activation bar (to facilitate communication), an antenna (to facilitate signal transmission), among other handheld radio components. The handheld radios may be used on a job site to facilitate management, coordination and resource control on the job site among other purposes.

As used herein, the term “job site” may refer to a construction site, a concert, and/or other site in which numerous personnel collectively and cooperatively engage in a construction, maintenance, and/or other project, such as those related to commercial, industrial, and event buildings, facilities, and equipment of all types. For the sake of non-limiting example, a job site may include: an oil and gas field in which personnel work on the maintenance of certain oil and gas equipment; a commercial building construction site in which personnel work on the construction of such building; an industrial facility in which personnel work on the assembly of certain items or components; a venue in which personnel work and collaborate to ensure an event proceeds as planned; and/or substantially any other site in which personnel may require the use of hand tools to perform project-specific job tasks or radios to communicate during, prior, or following said job tasks.

Conventional systems and toolboxes for construction related projects often lack the ability to track the usage and location of such handheld radios, for example, because the handheld radio may lack the functionality to be tracked by an external system, such as an on-site toolbox and/or other tracking system. Further, conventional techniques associated with mere affixation of an external tracking device on the handheld radio often fail to account for harsh working conditions on the jobsite and/or other factors that render such techniques undesirable. For example, external affixation of external tracking devices on handheld radios may be susceptible to dirt, debris, damage, theft and/or other drawbacks that limit the applicability of the tracking device.

To mitigate these and other challenges, the handheld radios of the present disclosure include a concealed beacon to facilitate the tracking of a location of the handheld radio on a job site. For example, the handheld radio may include a beacon configured to use short-range wireless signals (such as certain Bluetooth signals) to facilitate the tracking of the handheld radio relative to a self-inventorying tool container on said job site. The self-inventorying tool container (as described further herein) may be substantially analogous to any of the self-inventorying tool containers described in U.S. Non-Provisional application Ser. No. 18/925,959, entitled “Self-Inventorying Construction Tool Container and Methods of Use Thereof,” filed Oct. 24, 2024, which is incorporated by reference herein in its entirety. For example, the self-inventorying tool container may include a scanning assembly therein that is configured to track a location of associated handheld radios on the jobsite using the concealed beacon of each respective handheld radio. In order to mitigate the susceptibility of such beacon to dirt, debris, damage, theft and/or other drawbacks, the beacon may be concealed with the channel selector knob of the handheld radio. The channel selector knob may provide a sufficiently large interior cavity within which to conceal the beacon, and by which to establish a dust and debris resistant (e.g., such as having an IP68 environmental resistance rating) therein. In operation, jobsite personnel may operate the handheld radio, including operating the channel selector knob, notwithstanding the presence of the beacon concealed therein. Advantageously, despite having a concealed beacon, the handheld radio may appear similar to any handheld radio lacking a concealed beacon.

To facilitate the foregoing functionality, in one example, the handheld radio may include a radio body housing a communications component therein. The radio body may be a plastic shell, including a multi-piece structure that is configured to house the communications component and other electronic and functional components of the handheld radio. The communications component may be a transmitter, including a processing unit, and generally be operable to process the short-range wireless signals of the handheld radio in order to provide the half-duplex communication channel functionality described herein. The handheld radio may further include an antenna communicatively coupled with the communications component. The antenna may protrude from the radio body and be configured to deliver and receive a communications signal, such as any signal to facilitate said two-way communication. The handheld radio may further include at least two knobs. For example, the handheld radio may include a volume selector knob protruding from the radio body. The volume selector knob may be operable to change a volume of sound emanating from the radio body. Further, the handheld radio may include a channel selector knob protruding from the radio body. The channel selector knob may be operable to cause the antenna to deliver and receive said communications signal on one or more radio channels.

The handheld radio may further include a beacon (such as a Bluetooth low energy beacon) concealed therein. For example, the handheld radio may include the beacon concealed within the channel selector knob. By way of particular example, the channel selector knob may be a substantially hollow component configured to receive and conceal the beacon, along with other components associated therewith, including a printed circuit board or Printed Circuit Board (PCB) component, power source, wiring and/or other components. The channel selector knob may provide a substantially dust and/or debris free environment therein for the beacon and other such associated components, including defining a IP68 environmental resistance rating therein. The channel selector knob may provide a larger interior space for the beacon as compared with the volume selector knob. Further, the channel selector knob may be less susceptible to wear and tear as compared with the volume selector knob, for example, to the extent that said channel selector knob may be used with a lower frequency as compared to said volume selector knob. Despite the inclusion of the beacon within the channel selector knob, the channel selector knob may retain the ability to operate to change or tune the handheld radio to a particular channel, thereby offering a seamless experience for the operator the handheld radio while permitting external tracking of said handheld radio.

In operation, the handheld radio may be tracked (via the concealed beacon) using the self-inventorying tool container. For example, the self-inventorying tool container may include a scanning assembly that is configured to detect signals from each conceal beacon of any associated handheld radios. The scanning assembly, in cooperation with a processing unit and other associated modules of the self-inventorying tool container (as described herein) may use said detected signal from the beacons to determine a location of the handheld radios as being within the self-inventorying tool container, outside of the self-inventorying tool container, and/or being absent altogether (i.e., the beacon and associated tool is no longer on the job site, such as being outside the range of the scanning assembly). For example, the processing unit may be used to determine a Received Signal Strength Indicator (RSSI) value or other indicator of signal strength for the respective beacon, and to correlate said signal strength with a location of the beacon relative to the tool container (e.g., where a strong RSSI value may indicate a trackable tool is held within the tool container, a weak RSSI valve may indicate that said trackable tool is outside of the tool container, among other configurations). Such location information and other metrics may be transmitted to a remote location, including a central server, using an antenna and other components associated with the self-inventorying tool container.

The concealed beacons may also promote additional functionality, such as theft and tampering monitoring. For example, and as described herein, in response to the channel selector knob being operatively coupled with the radio body, the beacon may be configured to emit the short-range wireless signal having a first characteristic. Further, in response to the channel selector knob being detached from the radio body, the beacon may be configured to emit the short-range wireless signal having a second characteristic. The second characteristic may be indicative of said detachment of the channel selector knob from the radio body. The self-inventorying tool container may be configured to detect the wireless signal having the second characteristic and determine that the associated handheld radio has been tampered with or is otherwise in an inoperable state (e.g., with the beacon detached from the radio body). In turn, this information can be used to determine compliance with handheld radio tracking and promote efficiency radio management and maintenance thereof.

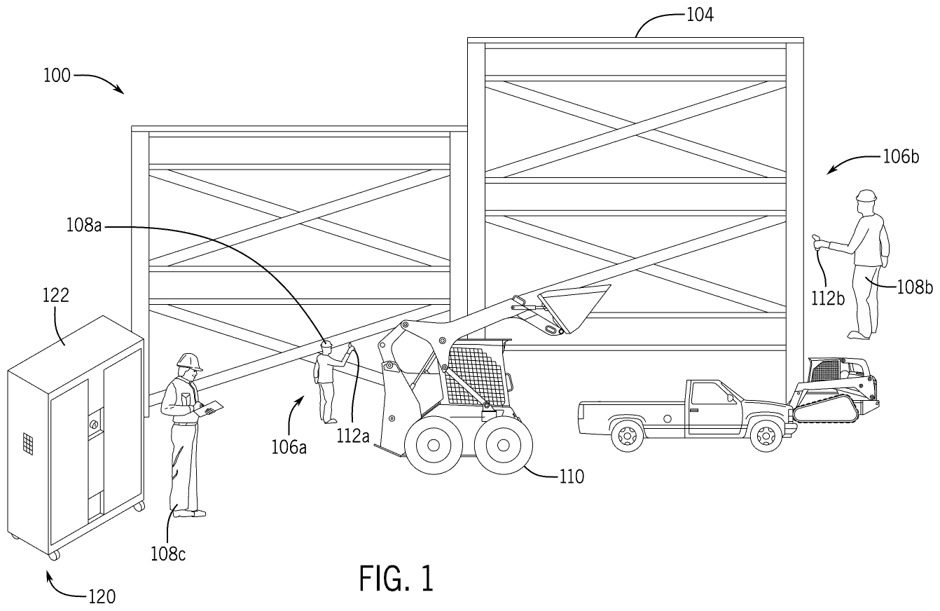

Turning to the Drawings, FIG. 1 depicts an example job site 100 including an example self-inventorying tool container 120, such as the self-inventorying tool containers discussed generally above, incorporated by reference herein, and described in greater detail below. The job site 100 is shown as a general construction site for assembly of a building 104, and is presented for purposes of illustration; however, as described herein, the job site 100 may be any site in which personnel are engaged in the collective completion of a construction, maintenance, and/or event related project. The job site 100 is further shown as including a plurality of workers (workers 108a, 108b, 108c), including a first worker 108a engaged in a first job task 106a using a first handheld radio 112a, and a second worker 100b engaged in a second job task 106b using a second handheld radio 112b. The job site 100 may further include example equipment 110.

The self-inventorying tool container 120 is shown as including a tool container structure 122. Broadly, the self-inventorying tool container 120 may be provided to the job site 100 including a plurality of trackable construction tools or equipment therein, including, for example, the handheld radios 112a, 112b. The self-inventorying tool container 120 may actively scan an interior of the tool container structure 122 to determine the presence of said tools, handheld radios, and equipment therein. At the job site 100, workers 108a, 108b, 108c may require use of the trackable construction tools and/or handheld radios held within the container structure 122 for a limited period of time. For example, the first worker 108a may require the first handheld radio 112a to facilitate the first job task 106a, while the second worker 108b may require the second handheld radio 112b to facilitate the second job task 106b. The self-inventorying tool container 120 may facilitate controlled release of the handheld radios 112a, 112b to the respective workers 108a, 108b, for example, by keeping such handheld radios locked within the container structure 122 until said worker enters a code or other identifier to release the tools to the appropriate worker. Further, the self-inventorying tool container 120 may operate (as described in further detail herein) to determine a location of the respective handheld radio 112a, 112b as being outside of the container structure 122 (and within the jobsite 100). In this regard, the job site 100 may be efficiently managed by securely releasing and tracking the handheld radios over the duration of the building project, among other benefits contemplated herein.

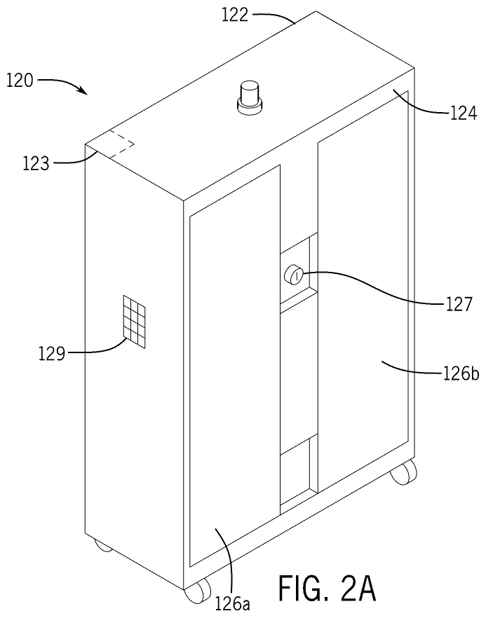

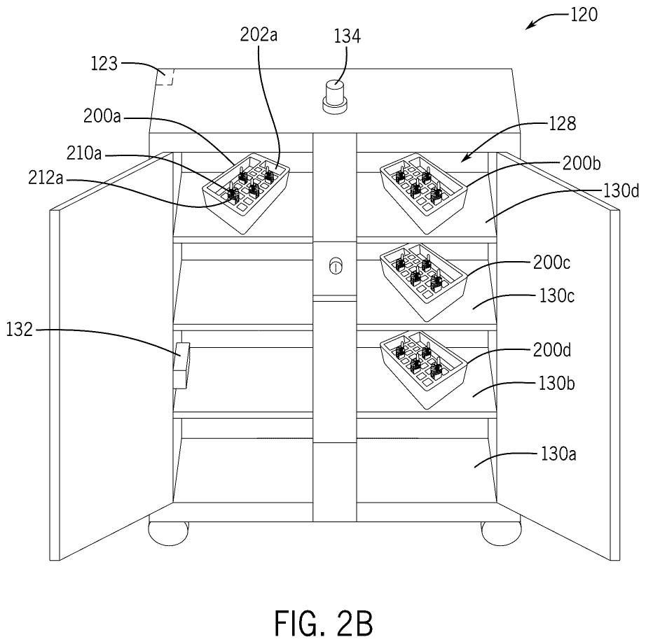

To facilitate the foregoing, by way of further example, the self-inventorying tool container 120 is shown in further detail in reference to FIGS. 2A and 2B. In FIG. 2A, the self-inventorying tool container 120 is shown in a closed or secure condition in which any trackable construction tools and/or handheld radios contained therein are concealed from view and locked therein pending release from authorized personnel. In FIG. 2B, the self-inventorying tool container 120 is shown in an open or released condition in which the trackable construction tools and/or handheld radios held therein are revealed such that the authorized personnel may retrieve or return a given trackable tool.

While many constructions are possible and contemplated herein, the self-inventory tool container 120 may include the tool container structure 122 that includes an enclosure 124 and doors 126a, 126b. The enclosure 124 may define an internal tool volume 128 therein and include a plurality of shelves (e.g., shelves 130a, 130b, 130c, 130d) for receipt of trackable construction tools, handheld radios, and/or other equipment or sensors of the container 120. The doors 126a, 126b may be coupled with enclosure 124 and operable to permit selective access to the internal tool volume 128 and any trackable construction and/or handheld radios tools held therein. While the tool container structure 122 is shown for purposes of illustration in FIGS. 2A and 2B as having a volume (e.g., 7 cubic feet, 16 cubic feet, and so on), in other examples, the tool container structure 122 may be smaller or larger, and have a different shape, based on a given application and usage.

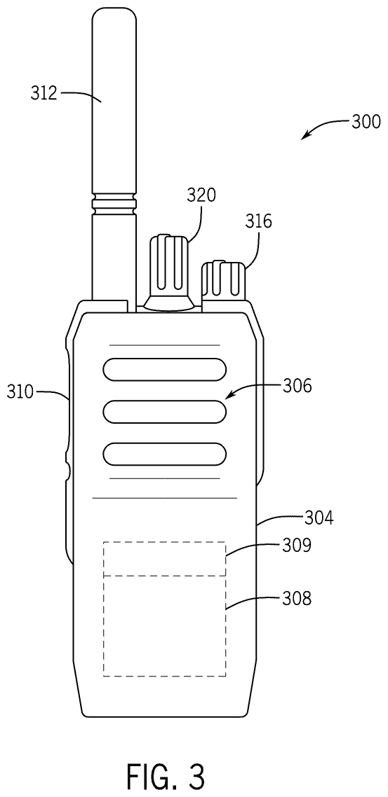

The self-inventorying tool container 120 is shown in FIGS. 2A and 2B as including a plurality of handheld radio containers, such as a first handheld radio container 200a, a second handheld radio container 200b, a third handheld radio container 200c, and a fourth handheld radio container 200d. Each of the radio containers may be configured to hold a plurality of handheld radios therein. In this regard, with reference to the example, first handheld radio container 200a, a handheld radio 210a is shown. The handheld radio 210a may be substantially analogous to any of the handheld radios described generally above, or as described in greater detail below in reference to FIGS. 3-6B. In this regard, the example handheld radio 210a may also include a beacon 212a. As described in greater detail herein, the beacon 212a may be a Bluetooth low energy beacon configured to emit a short-range wireless signal to facilitate tracking of the handheld radio 210a by the self-inventorying container 120. It will be appreciated that while one such handheld radio is described, the self-inventorying tool container 120 may include, for example, a plurality of handheld radios, each of which may include a concealed beacon, according to the techniques described herein, that is configured to transmit a short range wireless signal, such as a Bluetooth low energy and/or other like signal to facilitate tracking. As described herein, the beacon 212a may transmit such short-range wireless signals (each a “tracking signal”) periodically, both inside and outside of the container structure 122. Such signals may be unique to or otherwise keyed to or associated with each particular trackable handheld radio. Accordingly, based on a receipt of said tracking signal, the self-inventory tool container 120 may determine at least a location of said specific handheld radio as being either within the internal volume 128 or outside of the internal volume 128 (and on the job site, such as being within the job site 100).

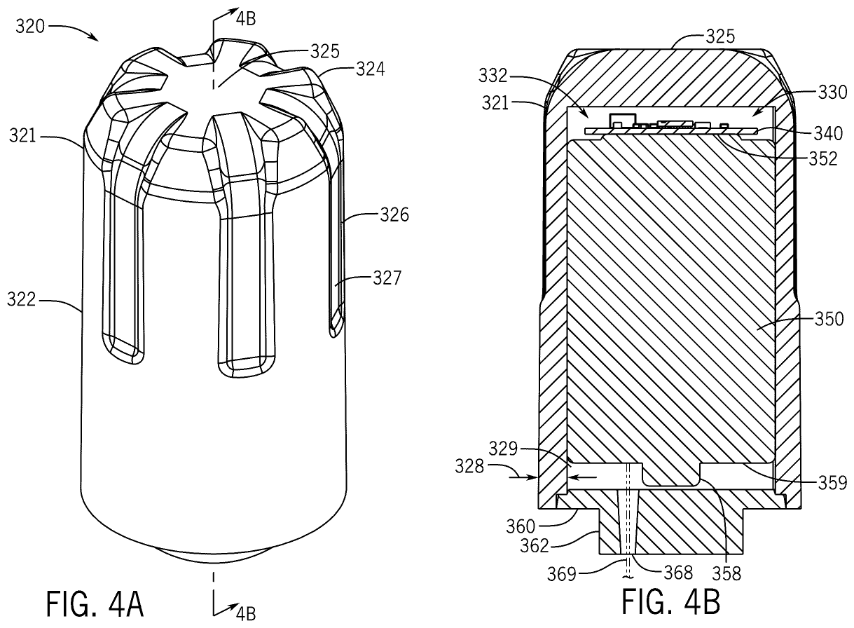

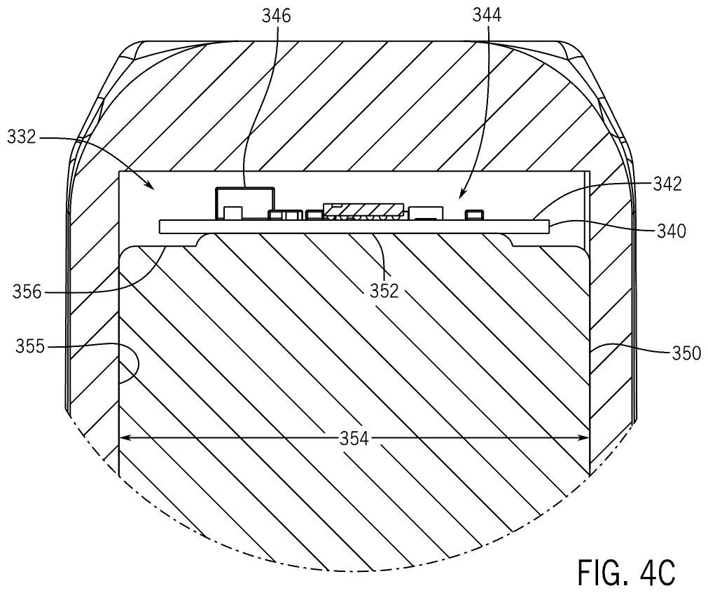

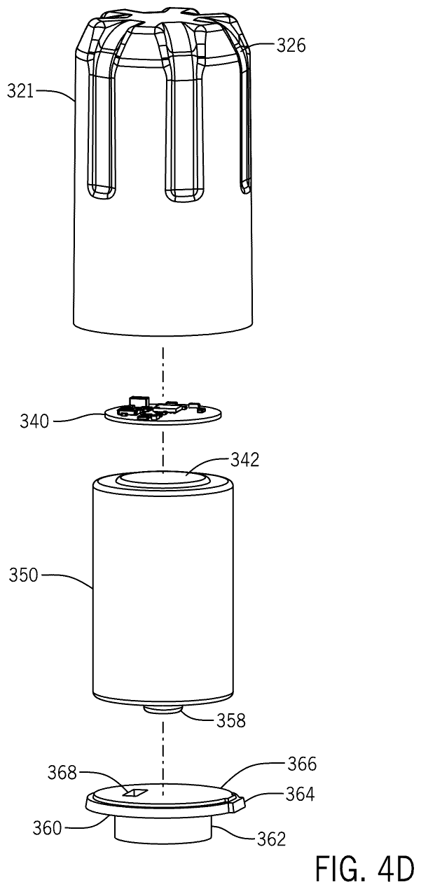

To facilitate the foregoing, the self-inventorying tool container 120 may include at least a scanning assembly 132. Broadly, the scanning assembly 132 may be arranged within the tool container structure 122 (e.g., within the internal tool volume 128) and configured to detect the short-range wireless—“tracking signals”—of each of the beacons (e.g., beacon 212a). In this regard, the scanning assembly may detect each such tracking signals relative to a location of the internal tool volume 128 such that the scanning assembly 132 may be used to determine a location of each associated radio based in part on a strength and directionality of each respective signal. As described in greater detail herein in reference to FIGS. 3 and 4, the scanning assembly 132 may include or be associated with a Bluetooth gateway, and collection of Bluetooth low energy scanners (including associated antennas), whereby the collection of such gateway, scanners, and antennas may operate to capture the signal from each respective beacon to determine said location.

With continued reference to FIGS. 2A and 2B, the self-inventorying tool container 120 is shown as including an antenna 123. Broadly, the antenna 123 may be arranged with the tool container structure 122 and may be configured to transmit a signal (each a “container signal”) indicative of a location of each trackable handheld radio and/or other construction tools therein to a remote location or remote server. In this regard, the antenna 123 may include a long-range wireless signal antenna, including certain cellular antennas to facilitate transmission directly from the job site to the remote location. The transmission of such container signals by the antenna 123 may permit the self-inventorying tool container 120 to provide data in substantially real time to a remote operations center or other location for further analysis and reporting the usage of the trackable construction tools, among other functions. The self-inventorying tool container 120 is further shown as including an indicator 134, which may be configured to generate an audio and/or visual alert in response to one or more events. For example, the indicator 134 may be configured to generate the audio and/or visual alert in order to indicate the presence of a handheld radio and/or other tool of interest within a given self-inventorying tool container of a job site, an evacuation event (including evacuation path and severity), and/or in response for the given self-inventorying tool container remaining open for predefined period (e.g., such as being open for longer than 2 minutes, 3 minutes, 4 minutes and/or other predefined period).

FIGS. 2A and 2B further show certain components of the access management system of the self-inventorying tool container 120, including the keypad 129 and a locking handle 127. Broadly, the self-inventorying tool container 120 may serve to secure access to the trackable handheld radios and/or other construction tools therein when not in use, and to permit access to such tools only to certain authorized personnel upon receipt of a uniquely identifying code or other indicator of access. For example, upon receipt of a uniquely identifying code at the keypad 129, the locking handle 127 may permit a worker to open doors 126a, 126b and reveal the interior tool volume 128 and any trackable handheld radios held therein. The opening of the doors 126a, 126b may therefore be associated with the specific worker for the uniquely identifying code. In this regard, as one or more handheld radios are removed from the interior tool volume 128 during the worker-specific period for which the doors 126a, 126b are opened, the self-inventorying container 120 can further associate the specific worker with such removed trackable handheld radios based on the change in each tool's respective tracking signal.

Turing to FIG. 3, an example handheld radio 300 is shown. The handheld radio 300 may be an example of any of the handheld radios described above in relation to FIGS. 1-2B (e.g., handheld radios 112a, 112b, 210a). The handheld radio 300 is shown as including a radio body 304. The radio body 304 may be a structural component of the handheld radio 300 that defines an outer shell or surface of the handheld radio 300. In some cases, radio body 304 may be a multi-component shell or other structure that cooperates to define the body. The shell may define one or more ports, opening, holes and the like to house and mount the various components described herein. For example, the handheld radio 300 is further shown in FIG. 3 as including a speaker 306. The speaker 306 may be housed within the radio body 304 and configured to emit sound therefrom, for example, as corresponding to communication received over a respective radio channel. Radio body 304 may define slots and/or other features to permit the flow of sound therethrough from the speaker 306 held therein.

FIG. 3 further shows the handheld radio 300 as including a communications component 308 and a power source 309. Each of the communications component 308 and the power source 309 are shown in dashed line and may be held entirely within the radio body 304. The communication component 308 may include a processing unit, transmitter and/or other communications component in order to facilitate the half-duplex communication of the two-way radio as described herein. The power source 309 may be substantially any battery, including certain rechargeable batteries, used to provide electrical power to the various electrical components of the handheld radio 300 included therewith. In some cases, the power source 309 may further be used to provide power to a beacon concealed within the volume selector knob of the handheld radio, as described in greater detail below.

The handheld radio 300 is further shown in FIG. 3 as including an antenna 312. The antenna 312 may be communicatively coupled with the communications component 308 and configured to send and receive various communications signals in order to facilitate the two-way communication described herein. As shown in FIG. 3, the antenna 312 may protrude from the radio body 304. The two-way communication of the handheld radio 300 may be initiated by an activation button 310. The activation button 310 may be pressed by a user in order to initiate a configuration whereby a user may speak toward the handheld radio 300, for example to a microphone embedded within the radio body 304 and a part of communication component 308, and cause the handheld radio 300 to transmit a communication signal to another handheld radio indicative of said user's spoken message.

FIG. 3 also shows the handheld radio 300 as including two knobs to facilitate the various operations of the handheld radio 300 described herein. For example, FIG. 3 shows a volume selector knob 316 protruding from the radio body 304. The volume selector knob 316 may be operable to change a volume of sound emanating from the radio body 304, such as that emanating from the speaker 306. Further, FIG. 3 shows a channel selector knob 320 protruding from the radio body 304. The channel selector knob 320 may be operable to cause the antenna 312 to deliver and receive certain communication signals on one or more radio channels. As described in greater detail herein, the handheld radio 300 may include a beacon (e.g., a Bluetooth beacon) and/or other tracking device concealed with a volume of selector knob 320. As used herein, the beacon is concealed in that channel selector knob 320 appears to resemble a non-Bluetooth enabled channel selector knob from the outside perspective. As will be discussed in greater detail in reference to FIG. 4A, the channel selector knob 320 may comprise a shell defining an exterior surface or user engagement surface configured to allow a user to twist the channel selector knob 320 to tune to different radio channels. The shell of the channel selector knob 320 may define an inner volume configured to house and conceal a beacon operable to provide tracking of the handheld radio 300.

Turing now to FIG. 4A, which depicts an isometric view of the channel selector knob 320 of the handheld radio 300 of FIG. 3. The channel selector knob 320 is shown as including a shell 321 having an elongated cylindrical portion 322. The shell 321 may be a structural component of the channel selector knob 320 serving as a component configured for user manipulation (e.g., twisting or rotation). In this regard, the shell 321 includes a cap portion 324 including a tip of shell 325, and user engagement surface 326 including one or more grooved features 327. Cap portion 324 may generally define an upper portion of the channel selector knob 320 extending from a topmost region of the cylindrical portion 322 and may further include the tip of shell 325 at the peak of the channel selector knob 320. User engagement surface 326 may include a plurality of groove features 327 positioned on upper portion of the elongated cylindrical portion 322 and configured to aid a user in gripping the channel selector knob 320 for manipulation. In this respect, the plurality of groove features 327 provide a nonuniform surface for the user to engage. In many examples, the shell 321 is configured to provide IP68 level environmental resistance within its internal volume, for example, to provide protection against dust, dirt, sand, and the like and/or to be able it to withstand submersion in liquid for up to thirty minutes. Shell 321 may be formed of a durable plastic material such as Acrylonitrile Butadiene Styrene (ABS), polycarbonate, Polyphenylsulfone (PPSU), Ultra High Molecular Weight Polyehtylene (UHMW) or the like.

In many examples, the shell 321 is substantially hollow and defines an inner volume to house and conceal a beacon within such IP68 level environmental resistance environment. Turning to FIG. 4B, which depicts a cross-sectional view of the channel selector knob 320 of FIG. 4A, taken along line 4B-4B of FIG. 4A, the channel selector knob 320 is shown as including an inner volume 330 defined by shell 321. The inner volume 330 is configured to conceal and house a beacon 340 within the container space 332. Advantageously, by being placed within the inner volume 330 of shell 321, the beacon 340 is concealed from an environment of the handheld radio 300. In many embodiments, shell 321 is configured to provide a IP68 environmental resistance rating to inner volume 330 and consequently to beacon 340. In this regard, inner volume 330 may provide a fully sealed environment for beacon 340 and associated components. To facilitate the foregoing, shell 321 is enclosed at a top portion by shell tip 325 and at a bottom portion by post 360, which may be pressed against and bound to shell wall 329.

The beacon 340 is generally configured to emit a short-range wireless signal thereby providing tracking capabilities of the handheld radio as described herein. In this regard, the beacon 340 may include a printed circuit board having one or more Bluetooth enable chips for sending (and optionally receiving) short range wireless signals, such as sending (And optionally receiving) certain Bluetooth signals. In many examples, and as depicted in FIG. 4B, channel selector knob 320 includes an inner structure 350 filling a substantial portion of the inner volume 330 and defining a seat 352 upon which beacon 340 is mounted, thereby positioning beacon 340 proximal to tip of shell 325 of shell 321. In some cases, the inner structure 350 may be a battery, and the seat 352 may be a terminal of said battery configured to provide power to the beacon 340. Additionally or alternatively, the inner structure 350 may provide a structural rest and mount for the beacon 340 such that the beacon is positioned near the tip 325.

Inner structure 350 may be of a size to fill a substantial portion of inner volume 330. In this regard, inner structure 350 may be configured to provide an upper space within inner volume 330 for beacon 340 to occupy. In several embodiments, the inner structure 350 and shell 321 cooperate to define container space 332 configured to establish an IP68 environment resistance rating therein. Beacon 340 may occupy said space. Additionally, inner structure 350 may include a terminal 358 (which may be a terminal of a battery, in some examples) positioned on a lower face of inner structure 350 to provide a lower space within inner volume 330 while mounting inner structure 350 to post 360. Advantageously, by providing inner structure 350, beacon 340 may be positioned elevationally offset and extending from handheld radio to improve the signal transmission capabilities of beacon 340.

The post 360 may be configured to enclose inner structure 350 within the container volume 332 by coupling to shell wall 329 of shell 321. In various embodiments, shell wall 329 includes divots or notches to snap-fit with corresponding protrusions of post 360, thereby providing a reversable seal. In one example, shell wall 329 is configured to attach to post 360 via compressive force 328. Post 360 may include or define a base engagement feature 362 for mounting channel selector knob 320 to a channel selector base component as described in greater detail below.

In many examples, beacon 340 is electrically coupled to a power source (e.g., power source 309) or other electrical component of handheld radio via wire connection. To facilitate the foregoing, beacon 340 may include (optional) wires 369 extending from beacon 340, through inner structure 350 and down to post 360. As illustrated in FIG. 4B, post 360 includes a wire through portion 368 defined within post 360 and occupied by wires 369, such that wires 369 may extend into the body of the handheld radio.

Turning to FIG. 4C, which depicts a detailed view of the cross-sectional view of the channel selector knob 320 shown in FIG. 4B. More particularly, FIG. 4C highlights components associated with beacon 340 and their position within container space 332. The beacon 340 may be generally operable to emit a short-range wireless signal (e.g., low-energy Bluetooth signal), for example received by scanning assembly 132 of self-inventorying tool container 120 thereby providing tracking functionality as described herein. To facilitate the foregoing, beacon 340 may be mounted to or otherwise coupled to a Printed Circuit Board or PCB 342 including PCB components 344. PCB 342 may generally provide a medium upon which associated electrical components (i.e., PCB components 344) of beacon 340 are mounted. PCB components 344 may generally include capacitors, resistors, transistors, diodes, oscillators, transformers, and the like. For example, PCB 342 includes transmitter 346 operable to provide the short-range wireless signal transmission capabilities described herein. For example, transmitter 346 may be operable to emit a Bluetooth lower energy signal operable to be received by scanning assembly 132 of self-inventorying tool container 120. Such signal may be emitted at a variable ping rate (e.g., between 1 and 30 seconds) and may be configured to have a range of up to 100 feet.

FIG. 4C further shows seat 352 upon which the beacon 342 is mounted. Seat 352 may be a protruding section of inner structure 350 elevationally offset from upper surface 356 of inner structure 350. Additionally, FIG. 4C depicts a width 354 of inner structure 350 as being substantially equal to a width of container space 332 such that inner structure 350 is pressed up against shell wall 355.

Turning now to FIG. 4D, which depicts an exploded view of the channel selector knob of FIG. 4A. As illustrated in FIG. 4D the channel selector knob 320 includes a post 360 at its lower end for engagement with a handheld radio (e.g., handheld radio 300) via a channel selector base component, discussed in more detail below. Post 360 is configured to couple to shell 321, such that internal structure 350 and beacon 340 are enclosed therein. To facilitate the foregoing post 360 includes face 366 for receiving terminal 358 of inner structure 350 and ledge 364 for engaging a lower section of shell 321. In several embodiments, ledge 364 and face 366 are configured to cooperatively create a snap-fit connection with shell 321. FIG. 4D further shows post 360 including slot 368, which may be a through portion of post 360 configured to receive electrical components (e.g., wires) to couple beacon 340 to a power source within the handheld radio (e.g., power source 309). Post 360 further includes base engagement feature 362 and ledge 364 for coupling to a channel selector base as discussed in greater detail below.

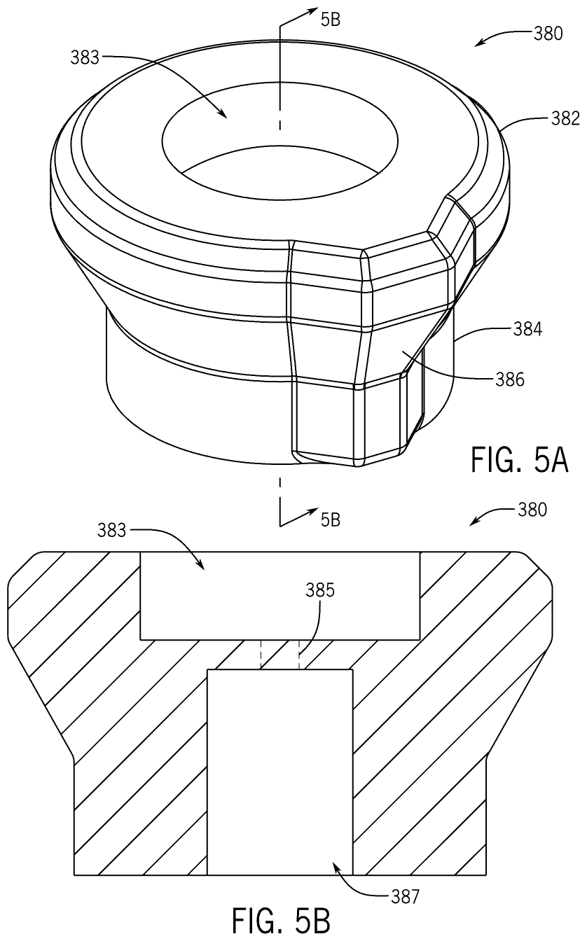

FIG. 5A depicts an isometric view of a channel selector base component 380. Channel selector base component 380 serves as an intermediate component for coupling the channel selector knob 320 to the handheld radio 300. To facilitate the foregoing, channel selector base component 380 includes a structure body 382 defining post engagement features 383 configured to couple to base engagement feature 362 of post 360. Post engagement feature 383 may be a cylindrical depression defined within structure body 382 of channel selector base component 380 sized to frictionally engage base engagement feature 362. FIG. 5A further shows radio engagement piece 384 positioned at a lower section of channel selector base component 380 and configured to engage with a corresponding component of the handheld radio (e.g., handheld radio 300).

As previously discussed, the channel selector knob of the present disclosure maintains its channel selection functionality while concealing a tracking beacon. For example, channel selector knob 320 may be manipulated by a user and in response to cause antenna 312 to deliver and receive communications signals on one or more radio channels via varying frequencies. While many constructions are possible and contemplated herein, such functionality may be accomplished by providing a channel selector base component with a channel indictor protrusion. For example, FIG. 5A illustrates channel indicator 386 protruding from structure body 382 of channel selector base component 380. Channel indicator 386 may be operable to engage with a corresponding component of a handheld radio 300 operable to cause antenna 312 to select a particular radio channel (i.e., frequency) and change or tune to a different radio channel via twist manipulation of the channel selector knob (e.g. via user engagement surface 326). In this respect, the channel selector knob 320 through its connection with channel selector base component 380 including channel indicator 386, may be manipulated to select certain radio frequencies thereby maintaining traditional functionality of a channel selector knob for handheld radios.

Turning now to FIG. 5B, which depicts a cross-sectional view of the channel selector base component 380 of FIG. 5A, taken along line 5B-5B of FIG. 5A. FIG. 5B highlights post engagement feature 383 as a depression within structure body 382 defined within a top portion of structure body 382. FIG. 5B further illustrates (optional) cord passage 385, which is a through portion coupling post engagement feature 383 to hollow portion 387. Cord passage 385 is configured to receive electrical component (e.g., wires) from beacon 340 (e.g., via wire through portion 368), to enable said electrical components to pass through channel selector base component 380, thereby providing power connection between beacon 340 and, for example, power source 390. Hollow portion 387 may be configured to engage with a corresponding protruding component of handheld radio 300 to couple the channel selector knob 320 to said handheld radio.

The channel selector knob of the present disclosure includes and conceals a beacon operable to emit a short-range wireless signal for tracking purposes. In several examples, the channel selector knob (via the beacon) is operable to emit a signal indicative of some kind of malfunction of the handheld radio potentially due to theft, damage, or the like. The channel selector knob is operable to automatically emit said signal in the event of a disconnect between the channel selector knob and the handheld radio. Advantageously, this functionality enables an operator to be notified when the channel selector knob has been removed from its associated handheld radio (e.g., via theft, damage, or the like) thereby indicating that the handheld radio can no longer be accurately tracked.

To facilitate the foregoing, the beacon is operable to emit a short-range wireless signal having a first characteristic or emit a short-range wireless signal having a second characteristic. The first characteristic may be indicative of normal operations of the beacon, that is where the channel selector knob is attached to its associated handheld radio and an operator can rely on the signal emitted therefrom to track the handheld radio. The second characteristics may be indicative of abnormal operations of the beacon, that is where the channel selector knob is detached from its associated handheld radio and the operator should not rely on the signal emitted therefrom to track the handheld radio.

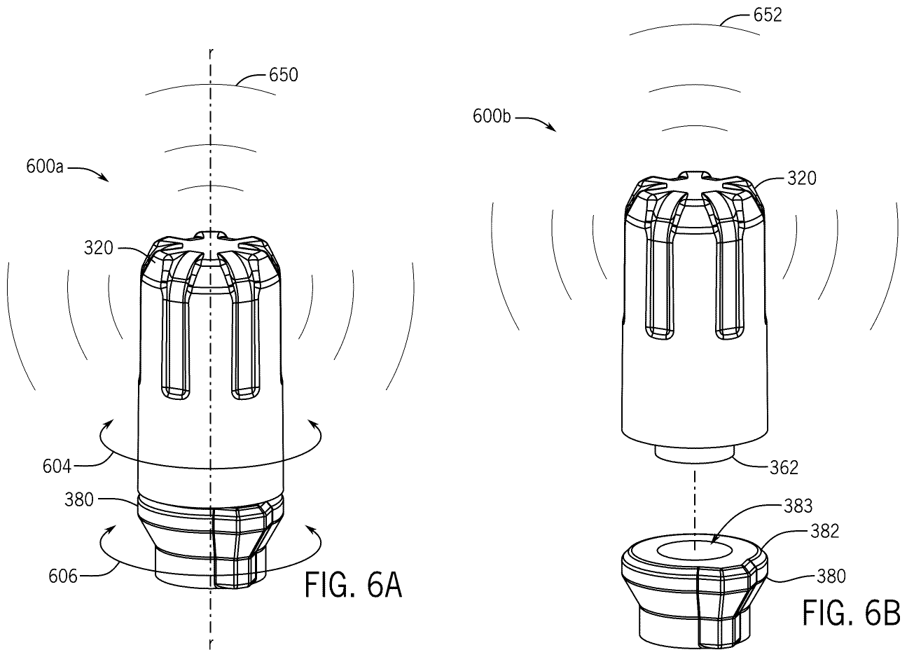

Turning now to FIG. 6A, which depicts a channel selector knob 320 assembly in a first configuration 600a. In the first configuration 600a the channel selector knob 320 (via a beacon contained therein) is operable to emit signal 650 (e.g., low-energy Bluetooth signal). In several embodiments, signal 650 is a short-range wireless signal configured to represent the normal operations of the channel selector knob 320, for example that the channel selector knob 320 and handheld radio are connected. Signal 650 may be configured to indicate to an operator that the handheld radio's location is accurately represented. In several embodiments, while in the first configuration 600a, the channel selector knob 320 is operable to be manipulated by a user via channel selector knob rotation 604, which in turn causes channel selector base rotation 606. As a consequence of said rotations, the channel selector knob 302 may cause an antenna (e.g., antenna 312) to adjust to detect the desired radio signal thereby enabling a user to select different radio channels via the channel selection knob 320.

FIG. 6B depicts a channel selector knob 320 assembly in a second configuration 600b. In the second configuration 600b the channel selector knob 320 (via a beacon contained therein) is operable to emit signal 652 (e.g., low-energy Bluetooth signal). In several embodiments, signal 652 is configured to represent abnormal operation of the channel selector knob 320, for example that the channel selector knob 320 and handheld radio are disconnected. Advantageously, this functionality notifies an operator that the handheld radio can no longer be accurately tracked and that signal 652 is indicative of the location of the channel selector knob 320, but not necessarily the handheld radio intended to be affixed thereto. Such functionality may be desirable to combat damage, theft, or the like. In many embodiments, beacon 340 is operable to automatically emit signal 652 upon disconnection from handheld radio 300. Trigger for said automatic action may be caused via disconnect of beacon 340 from power source 309.

Signals 650 and 652 may be short-range wireless Bluetooth (i.e., low energy) signals emitted by beacon 340. Such signals may be configured to be received by scanning assembly 132, thereby enabling the tracking functionality described herein. Signals 650 and 652 may be of a variable ping rate based on the need, for example between 1 and 30 seconds, and have a range of up to 100 feet. However, one of ordinary skill in the art will appreciate that the ping rate and range may be increased or decreased based on the need.

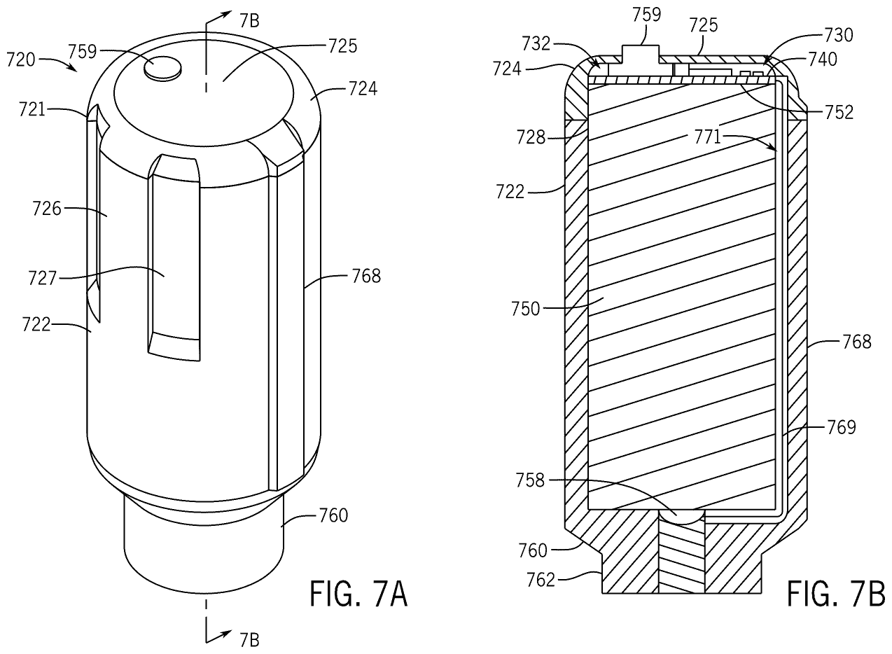

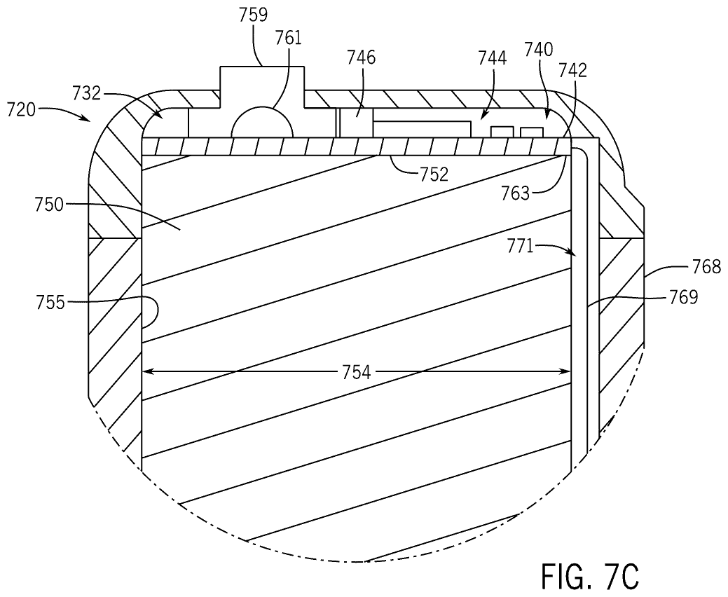

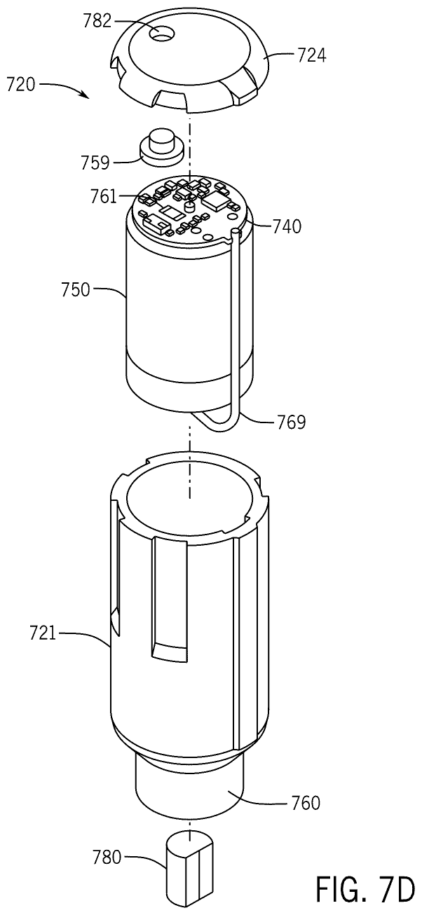

Turning now to FIG. 7A, which depicts an isometric view of another example channel selector knob 720 of the handheld radio 300 of FIG. 3. In many respects, example channel selector knob 720 is substantially analogous to channel selector knob 320 and is operable to facilitate all the same or substantially similar functionalities as channel selector knob 320 as disclosed herein. In this regard, channel selector knob 720 includes a shell 721 including an elongated cylindrical portion 722, a cap portion 724, a tip of the shell 725, user engagement surface 726, and one or more grooved features 727 redundant explanation of which is excluded for clarity. Additionally and as depicted in FIG. 7B, shell 721 may include a container space 732 defining an internal volume 730 configured to house a beacon 740 and an inner structure 750 defining a seat 752 for mounting said beacon 740, and include a post 760 including or otherwise defining a base engagement feature 762 redundant explanation of which is excluded for clarity. In this regard, example channel selector knob 720 and beacon 740 may be included or otherwise be coupled to handheld radio 300 in the same or substantially similar manner as channel selector knob 320, included as a component of self-inventorying tool container 120, and operable to effectuate the functionalities described with reference to FIGS. 1-2B, 6A-6B and 8-10. Furthermore, shell 721 may be generally operable to establish a IP68 level environmental resistance within an internal volume therein.

Notwithstanding the foregoing similarities, channel selector knob 720 may include certain different structural components and features than channel selector knob 320 despite operating in the same or substantially similar way. For example, channel selector knob 720 may include a detachable cap portion 724 configured to be removably attached to shell 721 so that beacon 740 and inner structure 750 may be positioned within container space 732. In this example, shell 721 and post 760 are a single manufactured piece rather than two distinct detachable pieces as described with reference to channel selector knob 320. In this regard, detachable cap portion 724 may be configured to snap-fit with shell 721 about inner shell wall 728. In one example, detachable cap portion 724 includes or defines a threaded portion corresponding to a threaded portion of inner shell wall 728 collectively configured to screw cap portion 724 onto shell 721.

As another example, channel selector knob 720 may house the power source for powering beacon 740 within shell 721. In this regard, inner structure 750 may be a battery operable to hold a charge and include a terminal 758 coupled to connecting wire 769 operable to power beacon 740. In this example and as illustrated in FIGS. 7A-7B, shell 721 may include or otherwise define conduit 768 defining conduit volume 771 for housing connector wire 769. Advantageously, this configuration provides beacon 740 with a power source independent of the handheld radio 300 thereby enabling continued functionality even where handheld radio 300 is out of charge.

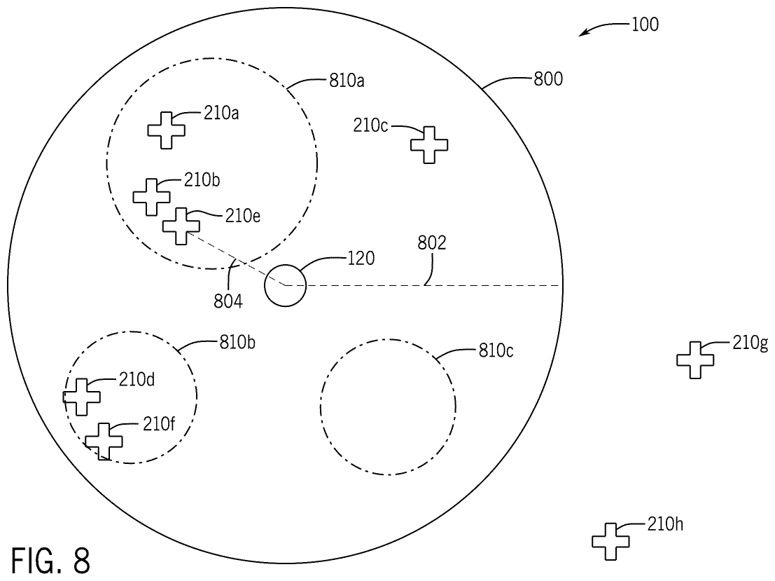

As another example and as illustrated in FIGS. 7A-7B, channel selector knob 720 may include a clear window 759 positioned about and extending out of cap portion 724. Clear window 759 may be coupled to beacon 740 and generally operable to enable light transfer therefrom. In this regard, beacon 740 may include or otherwise emit a light visible through clear window 759. In one example, the light emitted by beacon 740 through clear window 759 is representative of an operational state of the beacon, for example by emitting a green light indicating proper operation (e.g., active transmission of the Bluetooth signal) or emitting a red light indicating improper operation (e.g., inactive or improper transmission of the Bluetooth signal). In other examples, the light emitted by beacon 740 through clear window 759 is indicative of beacon 740's range from self-inventorying tool container 120 such that operators can be visually notified that they are out of a desired range of the self-inventorying tool container 120 or trackable region 800, greater details of which are described with reference to FIG. 8. In other examples, the light emitted by beacon 740 through clear window 759 may be programed to communicate various information to the operator (e.g., notification that the radio should be returned to self-inventorying tool container 120).

Turning now to FIG. 7C, which depicts a detailed view of the cross-sectional view of the channel selector knob 720 shown in FIG. 7B. More particularly, FIG. 7C highlights components associated with beacon 740 and its position within container space 732 of channel selector knob 720. As previously discussed, channel selector knob 720 and beacon 740 may be substantially analogous to channel selector knob 320 and beacon 340 and operable to facilitate the same or substantially similar functionalities as described herein. In this regard, FIG. 7C depicts container space 732, inner structure 750, shell wall 755, width 754, seat 752, beacon 740, PCB 742, PCB components 744, and transmitter 746 redundant explanation of which is excluded for clarity.

Notwithstanding the foregoing similarities, beacon 740 includes LED component 761 as included on PCB 742 and coupled to clear window 759. In this regard, beacon 740 may be operable to emit light via LED component 761 out of channel selector knob 720 via clear window 759. Additionally, FIG. 7C highlights connecting wire 769's connection to PCB 742 via port 763.

FIG. 7D depicts an exploded view of the channel selector knob 720 of FIG. 7A. As depicted in FIG. 7D, cap portion 724 may be detachable from shell 721 such that beacon 740 and inner structure 750 may be lowered down therein. Additionally, FIG. 7D depicts through portion 782 of cap portion 724. Through portion 782 may be sized to accommodate clear window 759. As previously discussed, channel selector knob 720 may be coupled to handheld radio 300 and operable to facilitate channel selection functionalities. To facilitate the foregoing, channel selector knob 720 may further include metal clip 780. In one example, metal clip 780 is couplable with post 760 and facilitates attachment to handheld radio 300 and channel selection functionality upon rotation of shell 721. In one example, metal clip 780 is a channel selector base operable to manipulate one or more electrical components within handheld radio 300, thereby altering a channel frequency to which the radio 300 is tuned. In this regard, post 760 encloses metal clip 780 in mating with the handheld radio 300.

FIG. 8 depicts a schematic top view of the example job site 100 of FIG. 1 including the example self-inventorying tool container 120. The self-inventorying tool container 120 may be configured to determine a location of trackable handheld radios (e.g., handheld radio 300) within a trackable region 800 from the container 120. The trackable region 800 may, in some circumstances, be defined by a trackable radius 802 of around 300 meters; however, in some cases, the trackable radius 802 may be more or less than 300 meters as needed for a given application. The self-inventorying tool container 120 may be configured to determine a location of trackable handheld radios within the trackable region 800, for example, such as determining that a trackable tool 210e is arranged at a location at a distance 804 from the self-inventorying tool container 120. In some cases, the self-inventorying tool container 120 may determine, based on the location of trackable handheld radios, that the trackable handheld radios are be used on or otherwise associated with a specific job task or sub region of the trackable region 800; such as determining that trackable handheld radios 210a, 210b, 210e are each associated with a job task region 810a, trackable handheld radios 210d, 210f are associated with a job task region 810b, and no trackable handheld radios are associated with job task region 810c. Such analysis can provide real-time metrics indicative of the effective utilization of handheld radios on the job site, for example, by indicating which radios are being used for which job task, and even where radios are being used for other non-assigned job tasks (e.g., such as where trackable handheld radio 210c should be associated with the job task region 810c but is otherwise absent therefrom). The self-inventorying tool container 120 may also provide an indication of trackable handheld radios that are missing altogether from the job site 100, such as may be the case for trackable handheld radios 210g, 210h, which are shown as being outside of the trackable region 800.

It will be appreciated that multiple self-inventorying tool containers 120 may be used on a single job site. For example, a job site may include a first self-inventorying tool container, a second inventorying tool container, and a third self-inventorying tool container, each of which may be substantially analogous to the self-inventorying tool container 120 described herein. Multiple such containers may be provided to the job site in order to maximize the region across which trackable tools may be detected. For example, the first self-inventorying tool container may be associated with a first trackable region, the second self-inventorying tool container may be associated with a second trackable region, and the third self-inventorying tool container may be associated with a third trackable region, with such trackable regions, collectively, covering a majority of the footprint of the job site. Furthermore, the containers may be coupled to one another in order to provide information concerning the location of specific a trackable handheld radio as among the containers. For example, personnel on the job site may access a mobile device and query the location of a specific tool. Said personnel may receive an indication of the specific container of the containers that the given trackable handheld radio is located. Further, the LED beacon 134 or other alerting device of the container 120 may produce an alert at the particular container where the trackable tool is located. Further, each of the containers may cooperate to produce other alerts that support personnel and job site safety, including evacuations. For example, in response to an evacuation event on the job site for any number of job site-specific safety rationales, the containers may produce an audio or visual alert that indicate the evacuation event and/or type. In some cases, the alerts may be sequenced to indicate one or both of an evacuation route or a severity of an evacuation event, among other options.

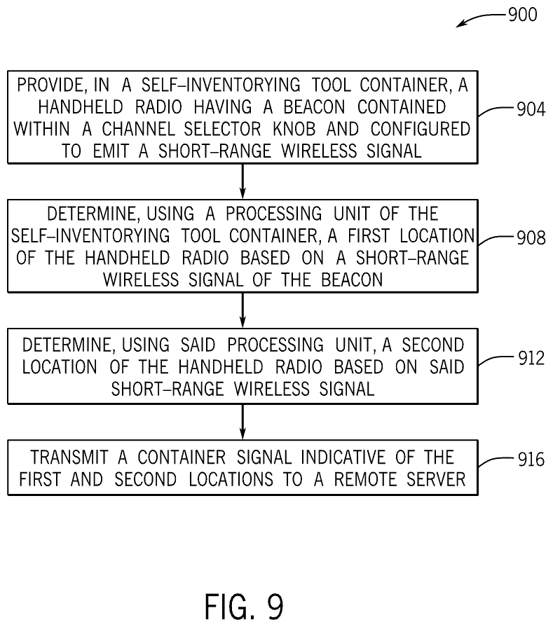

FIG. 9 depicts a flow diagram of an example method 900 for tracking handheld radios on a job site. At operation 904, a handheld radio having a beacon contained within a channel selector knob and configured to emit a short-range wireless signal in a self-inventorying tool container is provided. For example, and with reference to FIGS. 1-2B, the self-inventorying tool container 120 is provided to the job site 100. The self-inventorying tool container 120 includes the trackable handheld radios (e.g., handheld radio 210a, 300), each having associated beacons (e.g., beacon 212a, 340, 740). At operation 908, a first location of a trackable handheld radio is determined using a processing unit of the self-inventorying tool container based on a short-range wireless signal of the beacon. For example, and with reference to FIGS. 1-2B and 8, the trackable handheld radio 210a is determined as having a first location, for example inside the internal tool volume 128. At operation 912, a second location of the trackable handheld radio is determined as being at a second location, for example disposed outside of the container and within the jobsite. For example, and with reference to continued reference FIGS. 1-2B and 8, the trackable radio 210a is determined as having a location outside of the internal tool volume 128, such as being employed at various job tasks about the job site 100. As another example, the trackable radio 210a may be determined as having a location within a job task region 810a, 810b, 810c or as having a location outside trackable region 800. At operation 916, a container signal indicative of the first and second locations is transmitted to a remote server. For example, and with reference to FIGS. 1-2B, one or more processing units of the self-inventorying tool container 120 may analyze said signals from the trackable construction tools and transmit said signals to a remote location via the antenna 123. In this regard, a remote server and associated central monitoring facility can monitor the usage and location of said trackable radios in substantial real-time.

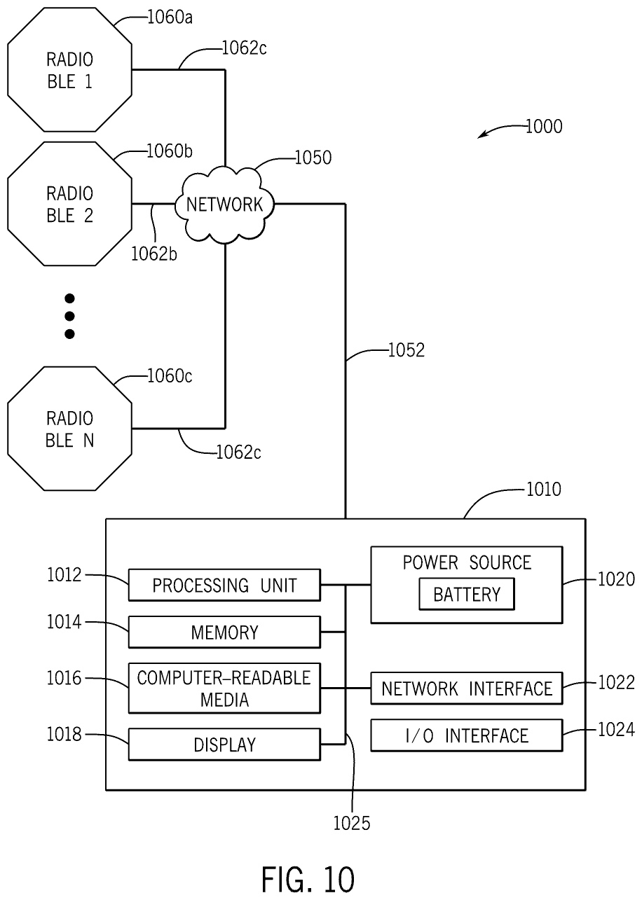

FIG. 10 depicts a functional block diagram 1000 of a computer-implemented device 1010 couplable with a plurality of radios over a communications network. The schematic representation in FIG. 10 is generally representative of any types of systems and configurations that may be used to receive a sensor signal in accordance with the embodiments described herein. For example, the device 1000 may be used with or included within, or be included as part of, or used to control any of the Bluetooth gateways, scanners, beacons, transmitters, antennas, computers, user interfaces, or computer modules described herein. In this regard, the device 1010 may include any appropriate hardware (e.g., computing devices, data centers, switches), software (e.g., applications, system programs, engines), network components (e.g., communication paths, interfaces, routers) and the like (not necessarily shown in the interest of clarity) for use in facilitating any appropriate operations disclosed herein.

As shown in FIG. 10, the device 1010 may include a processing unit or element 1012 operatively connected to computer memory 1014 and computer-readable media 1016. The processing unit 1012 may be operatively connected to the memory 1014 and computer-readable media 1016 components via an electronic bus or bridge (e.g., such as system bus 1025). The processing unit 1001 may include one or more computer processors or microcontrollers that are configured to perform operations in response to computer-readable instructions. The processing element 1012 may be a central processing unit of device 1010. Additionally or alternatively, the processing unit 1012 may be other processors within the device including application specific integrated chips (ASIC) and other microcontroller devices.

The memory 1014 may include a variety of types of non-transitory computer-readable storage media, including, for example, read access memory (RAM), read-only memory (ROM), erasable programmable memory (e.g., EPROM and EEPROM), or flash memory. The memory 1014 is configured to store computer-readable instructions, sensor values, and other persistent software elements. Computer-readable media 1016 may also include a variety of types of non-transitory computer-readable storage media including, for example, a hard-drive storage device, a solid state storage device, a portable magnetic storage device, or other similar device. The computer-readable media 1016 may also be configured to store computer-readable instructions, sensor values, and other persistent software elements.

The processing unit 1012 may be operable to read computer-readable instructions stored on the memory 1014 and/or computer-readable media 1016. The computer-readable instructions may adapt the processing unit 1012 to perform the operations or functions described above with respect to FIGS. 1-9. The computer-readable instructions may be provided as a computer-program product, software application, or the like.

As shown in FIG. 10, the device 1010 may also include a display 1018. The display 1018 may include a liquid-crystal display (LCD), organic light emitting diode (OLED) display, light emitting diode (LED) display, or the like. If the display 1018 is an LCD, the display may also include a backlight component that can be controlled to provide variable levels of display brightness. If the display 1018 is an OLED or LED type display, the brightness of the display 1018 may be controlled by modifying the electrical signals that are provided to display elements. In some embodiments, display 1018 is operable to display information pertaining to the tracking of the handheld radios described herein.

The device 1010 may also include a power source 1020 that is configured to provide electrical power to the components of device 1010. For example, power source 1020 may be power source 309 configured to provide power to communication component 308, beacon 340, beacon 740 and other powered components described herein. The power source 1020 may include one or more power storage cells that are linked together to provide an internal supply of electrical power. In this regard, the power source 1020 may be a component of a power source 3010 (e.g., including a charging system or other circuitry that supplies electrical power to components of the device 1010). The power source 1020 may be operatively coupled to power management circuitry that is configured to provide appropriate voltage and power levels for individual components or groups of components within the device 1010. The power source 1020, via power management circuitry, may be configured to receive power from an external source, such as an AC power outlet or interconnected computing device. The power source 1020 may store received power so that the device 1010 may operate without connection to an external power source for an extended period of time, which may range from several hours to several days.

The device 1010 may also include a communication port comprising a network interface 1022 and/or I/O interface 1024 that is configured to transmit and/or receive signals or electrical communication from an external or separate device. The communication port may be configured to couple to an external device via a cable, adaptor, or other type of electrical connector. In some embodiments, the communication port may be used to couple the device 1010 with a computing device and/or other appropriate accessories configured to send and/or receive electrical signals. The communication port may be configured to receive identifying information from an external accessory, which may be used to determine a mounting or support configuration. For example, the communication port may be used to determine that the device 1010 is coupled to a mounting accessory, such as a particular type of stand or support structure.

In several embodiments, 1010 is communicatively coupled to network 1050 via connection 1052. Network 1050 may be further communicatively coupled to a plurality of radio beacons 1060a, 1060b, 1060c via connections 1062c, 1062b, 1062c. For example, network 1050 may be scanning assembly 132, connection 1062a, 1062b, 1062c may be short-range wireless signals (e.g., signal 650) from a plurality of beacons (e.g., beacon 212a, 340, 740). In this regard, device 1010 (e.g., a remote computer) may then be operable to receive tracking information of a plurality of handheld radios via connection 1052 (e.g., signal emitted from antenna 123).

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A handheld radio for a job site, the handheld radio comprising
a radio body housing a communications component therein;
an antenna communicatively coupled with the communications component and protruding from the radio body and configured to deliver and receive a communications signal;
a volume selector knob protruding from the radio body and operable to change a volume of sound emanating from the radio body; and
a channel selector knob protruding from the radio body and operable to cause the antenna to deliver and receive the communications signal on one or more radio channels,
wherein the channel selector knob includes a beacon configured to emit a short-range wireless signal.

2. The handheld radio of claim 1, wherein the short-range wireless signal comprises a Bluetooth low energy signal.

3. The handheld radio of claim 1, wherein
the channel selector knob comprises a shell defining a user engagement surface of the channel selector knob and an inner volume defined therein, and
the beacon is arranged in the inner volume and concealed from an exterior environment by the user engagement surface.

4. The handheld radio of claim 3, wherein
the channel selector knob further comprises an inner structure filling a substantial portion of the inner volume and defining a seat for the beacon proximal a tip of the shell, and
the beacon is fixed to the seat.

5. The handheld radio of claim 4, wherein
the inner structure and the shell cooperate to define a containment space in the inner volume that establishes an IP68 environmental resistance rating, and
the beacon is fixed to the seat at and arranged fully within said containment space.

6. The handheld radio of claim 4, wherein
the handheld radio further comprises a channel selector base connected with the radio body and operative to manipulate one or more electrical components therein, and
the channel selector knob further comprises a post that closes the channel selector knob shell opposite the tip and is mated with the channel selector base.

7. The handheld radio of claim 6, wherein rotation of the channel selector knob causes a manipulation of the one or more electrical components via a corresponding rotation of the mated channel selector base.

8. The handheld radio of claim 7, wherein the beacon is electrically coupled to a power source of the handheld radio via the mated channel selector base and post.

9. The handheld radio of claim 7, wherein the beacon is electrically coupled to a power source independent of a power source of the handheld radio via a conduit defined by the shell.

10. The handheld radio of claim 1, wherein the beacon is configured to emit the short-range wireless signal at a variable ping rate configurable to between 1 to 30 seconds.

11. The handheld radio of claim 1, wherein
in response to the channel selector knob being operatively coupled with the radio body, the beacon is configured to emit the short-range wireless signal having a first characteristic,
in response to the channel selector knob being detached from the radio body, the beacon is configured to emit the short-range wireless signal having a second characteristic, and
the second characteristic is indicative of said detachment of the channel selector knob from the radio body.

12. The handheld radio of claim 1, wherein the beacon is configured to transmit said short-range wireless signal to a self-inventorying tool container for determination of a physical location of the handheld radio relative to the self-inventorying tool container.

13. The handheld radio of claim 11, wherein the beacon is configured to transmit said short-range wireless signal up to 100 feet.

14. The handheld radio of claim 1, wherein the channel selector knob resembles a non-Bluetooth enabled channel selector knob.

15. The handheld radio of claim 1, wherein the channel selector knob is configured to emit a light associated with an operational state of the beacon.

16. A channel selector knob for a handheld radio, the channel selector knob comprising
a shell defining a user engagement surface of the channel selector knob and an inner volume defined therein;
a beacon configured to emit a short-range wireless signal and arranged in the inner volume, the beacon concealed from an exterior environment by the user engagement surface;
an inner structure filling a substantial portion of the inner volume and defining a seat for the beacon proximal a tip of the shell, wherein the beacon is fixed to the seat; and
a post that closes the channel selector knob shell opposite the tip and defines a mating feature configured for engagement with a channel selector base of a handheld radio.

17. The channel selector knob of claim 16, wherein the short-range wireless signal comprises a Bluetooth low energy signal.

18. The channel selector knob of claim 16, wherein
the inner structure and the shell cooperate to define a containment space in the inner volume that establishes an IP68 environmental resistance rating, and
the beacon is fixed to the seat at and arranged fully within said containment space.

19. The channel selector knob of claim 16, wherein a rotation of the post is configured to cause a manipulation of one or more electrical components of the handheld radio via a corresponding rotation of a mated channel selector base.

20. The channel selector knob of claim 16, wherein the beacon is electrically couplable to a power source of the handheld radio via a mated channel selector base and post.

21. A method for tracking handheld radios on a job site, the method comprising
providing the handheld radio of claim 1 to the job site within a self-inventorying tool container;
determining, using a processing unit of the self-inventorying tool container, a first location of the handheld radio based on the short-range wireless signal;
determining, using the processing unit, a second location of handheld radio based on the short-range wireless signal; and
transmitting a container signal indicative of the first and second locations to a remote server.

22. The method of claim 21, further comprising, using the processing unit, developing a report including a utilization metric of the handheld radio on the job site, the utilization metric indicative of a time said handheld radio is disposed outside of self-inventorying tool container.

23. The method of claim 21, further comprising
providing a plurality of the handheld radio of claim 1 to the job site within the self-inventorying tool container, and
determining, using the processing unit, a subsequent location for each handheld radio of the plurality of handheld radios based on the short-range wireless signals of each respective beacon of said plurality handheld radios.

24. The method of claim 21, further comprising detecting a separation event of the handheld radio in which the channel selector knob is detached from the radio body based on a change in a characteristic of the short-range wireless signal caused by said separation event.
